(19) United States
(12) Patent Application Publication
(10) Pub. No.: US 2024/0361623 A1
(43) Pub. Date: Oct. 31, 2024

(54) OPTICAL MODULATOR

(71) Applicant: Murata Manufacturing Co., Ltd., Nagaokakyo-shi (JP)

(72) Inventors: Satoki HAMAMURA, Nagaokakyo-shi (JP); Yasuhiro AIDA, Nagaokakyo-shi (JP)

(21) Appl. No.: 18/768,269

(22) Filed: Jul. 10, 2024

Related U.S. Application Data
(63) Continuation of application No. PCT/JP2023/022849, filed on Jun. 21, 2023.

(30) Foreign Application Priority Data
Nov. 30, 2022 (JP) 2022-192106

(51) Int. Cl. G02F 1/035

(52) U.S. Cl. CPC G02F 1/035; G02F 2201/12; G02F 2202/16

(57) ABSTRACT

An optical modulator includes an optical waveguide including a material having an electro-optic effect, a first electrode, and a second electrode. The first electrode includes a semiconductor material. The second electrode includes a metal material and is positioned to provide a potential difference with respect to the first electrode to apply an electric field to the optical waveguide.

### CROSS REFERENCE TO RELATED APPLICATIONS

This application claims the benefit of priority to Japanese Patent Application No. 2022-192106 filed on Nov. 30, 2022 and is a Continuation Application of PCT Application No. PCT/JP2023/022849 filed on Jun. 21, 2023. The entire contents of each application are hereby incorporated herein by reference.

### BACKGROUND OF THE INVENTION

### 1. Field of the Invention

The present disclosure relates to optical modulators.

### 2. Description of the Related Art

With spread of mobile terminals and cloud services, internet communication usage has been significantly increased, which increases demand for optical communication. The optical communication requires an optical transceiver to perform conversion between optical signals and electrical signals. The optical transceiver includes an optical modulator as a main component. The optical modulator plays a role in converting electrical signals to optical signals.

Existing optical modulators are described in Japanese Unexamined Patent Application Publication No. 2020-034610 and Integrated lithium niobate electro-optic modulators: when performance meets scalability, Mian Zhang, et al., Optica Vol. 8, Issue 5, pp. 652-667 (2021), for example. The optical modulator described in Japanese Unexamined Patent Application Publication No. 2020-034610 includes a core portion having a slot-waveguide structure. The core portion includes an upper high-refractive-index layer, a lower high-refractive-index layer, and a low-refractive-index layer provided at a gap (slot) between these high-refractive-index layers. Refractive indexes of the upper and lower high-refractive-index layers are higher than a refractive index of the low-refractive-index layer. Each of the upper and lower high-refractive-index layers has a contact region. A metal electrode is connected to each of the contact regions.

The optical modulator described in Integrated lithium niobate electro-optic modulators: when performance meets scalability, Mian Zhang, et al., Optica Vol. 8, Issue 5, pp. 652-667 (2021) includes an optical waveguide and two metal electrodes. The optical waveguide is disposed between the two metal electrodes. For example, one of the metal electrodes, the optical waveguide, and the other one of the metal electrodes are disposed in parallel. Alternatively, one of the metal electrodes is laminated on the optical waveguide, and the other one of the metal electrodes is laminated on the optical waveguide at the opposite side. The two electrodes are disposed to apply an electric field to the optical waveguide.

In order to apply broadband and high-frequency signals to an electrode while suppressing power consumption, a thickness of the electrode is preferably large. However, when the electrode is formed by using metal material as the existing optical modulator, an increase in the thickness of the electrode causes large internal stress in the electrode. Due to this internal stress, the electrode is susceptible to cracking. Particularly, when two metal electrodes are disposed while being laminated on both sides of an optical waveguide, internal stress such that both electrodes are warp-deformed in the same direction is generated in each electrode. Therefore, the optical waveguide warp-deforms together with both the electrodes, and the optical waveguide is also susceptible to cracking.

### SUMMARY OF THE INVENTION

Example embodiments of the present invention provide optical modulators each able to apply an electrical signal to an electrode while reducing or preventing cracking and power consumption.

An optical modulator according to an example embodiment of the present invention includes an optical waveguide, a first electrode, and a second electrode. The optical waveguide includes a material with an electro-optic effect. The first electrode includes a semiconductor material. The second electrode includes a metal material and is positioned to provide a potential difference with respect to the first electrode to apply an electric field to the optical waveguide.

The optical modulators according to example embodiments of the present invention are each able to apply an electrical signal to the electrode while reducing or preventing cracking and power consumption.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a sectional view illustrating a schematic configuration of an optical modulator according to a first example embodiment of the present invention.

FIG. 2 is a sectional view illustrating a schematic configuration of an optical modulator according to a second example embodiment of the present invention.

FIG. 3 is a sectional view illustrating a schematic configuration of an optical modulator according to a third example embodiment of the present invention.

FIG. 4 is a sectional view illustrating a schematic configuration of an optical modulator according to a fourth example embodiment of the present invention.

FIG. 5 is a sectional view illustrating a schematic configuration of an optical modulator according to a fifth example embodiment of the present invention.

FIG. 6 is a view illustrating a modification of the optical modulator according to the fifth example embodiment of the present invention.

FIG. 7 is a sectional view illustrating a schematic configuration of an optical modulator according to a sixth example embodiment of the present invention.

FIG. 8 is a sectional view illustrating a schematic configuration of an optical modulator according to a seventh example embodiment of the present invention.

FIG. 9 is a sectional view illustrating a schematic configuration of an optical modulator according to an eighth example embodiment of the present invention.

FIG. 10 is a sectional view illustrating a schematic configuration of an optical modulator according to a ninth example embodiment of the present invention.

FIG. 11 is a sectional view illustrating a schematic configuration of an optical modulator according to a tenth example embodiment of the present invention.

FIG. 12 is a view illustrating a modification of the optical modulator according to the tenth example embodiment of the present invention.

### DETAILED DESCRIPTION OF THE EXAMPLE EMBODIMENTS

Hereinafter, example embodiments of the present invention will be described in detail with reference to the drawings. Although in the following description the example embodiments of the present invention are described while provided examples, the present invention is not limited to the examples described below. Although specific numerical values and specific materials may be exemplified in the following description, the present invention is not limited to those exemplified.

An optical modulator according to an example embodiment of the present invention includes an optical waveguide, a first electrode, and a second electrode. The optical waveguide includes a material having an electro-optic effect. The first electrode includes a semiconductor material. The second electrode includes a metal material and is positioned to provide a potential difference with respect to the first electrode to apply an electric field to the optical waveguide (first configuration).

In the first configuration, among the first electrode and the second electrode which apply an electric field to the optical waveguide, the first electrode is a semiconductor electrode including a semiconductor material. The semiconductor electrode may have a larger thickness while reducing or preventing internal stress when compared to a metal electrode. With the semiconductor electrode having an increased thickness, broadband and high-frequency signals can be applied to the semiconductor electrode while reducing or preventing power consumption. Moreover, the semiconductor electrode is formable while reducing or preventing internal stress, and thus the occurrence of cracks attributed to the internal stress can be reduced or prevented.

In a first configuration, among the first electrode and the second electrode which apply an electric field to the optical waveguide, the second electrode is a metal electrode made of a metal material. The metal material of the second electrode has higher conductivity than a semiconductor material. Therefore, when compared to a case in which both of the first electrode and the second electrode are semiconductor electrodes, electrical loss can be reduced or prevented.

The optical modulator of the first configuration may further include a low-permittivity layer having a refractive index smaller than a refractive index of the optical waveguide. In this case, at least the first electrode among the first electrode and the second electrode may be disposed while including a gap with respect to the optical waveguide, and the low-permittivity layer may be provided at the gap (second configuration). Each of the first electrode and the second electrode may be disposed while including a gap with respect to the optical waveguide, and the low-permittivity layer may be provided at each gap (third configuration).

In a second configuration, a gap is provided between at least the first electrode that is the semiconductor electrode and the optical waveguide. In this case, the first electrode is not in contact with the optical waveguide. Furthermore, the low-permittivity layer with smaller refractive index than that of the optical waveguide is provided at the gap between the first electrode and the optical waveguide. Therefore, light which passes through the optical waveguide becomes more unlikely to leak with respect to the first electrode, and light loss can be reduced or prevented.

In a third configuration, a gap is provided between both of the first electrode and the second electrode and the optical waveguide. Furthermore, the low-permittivity layer with smaller refractive index than that of the optical waveguide is provided at each of the gap between the first electrode and the optical waveguide and the gap between the second electrode and the optical waveguide. Therefore, light which passes through the optical waveguide becomes more unlikely to leak with respect to each of the first electrode and the second electrode, and light loss can be further reduced or prevented.

In the optical modulator of the second or third configuration, for example, preferably, the size of the gap is about 0.750 μm or more and about 1.675 μm or less (fourth configuration).

Light, although it is faint, seeps from the optical waveguide to the low-permittivity layer. This seeped light is referred to as evanescent light. As in the fourth configuration, when the gap(s) between the first electrode and/or the second electrode and the optical waveguide has the size of about 0.750 μm or more, the evanescent light is more unlikely to contact the first electrode and/or the second electrode, and light loss can be further reduced or prevented.

In the fourth configuration, the gap(s) between the first electrode and/or the second electrode and the optical waveguide has the size of, for example, about 1.675 μm or less. In this case, a distance between the first electrode and/or the second electrode and the optical waveguide is not too large, and intensity of the electric field with respect to the optical waveguide can be ensured without making voltage applied between the first electrode and the second electrode large.

In any one of the optical modulators having the second to fourth configurations, the semiconductor material may be, for example, a silicon semiconductor material in which silicon is applied with impurity doping, and a main component of the low-permittivity layer may be SiO₂ (fifth configuration). The semiconductor material is the silicon semiconductor material, and thus in the case in which the low-permittivity layer is provided between the first electrode and the optical waveguide, the SiO₂ low-permittivity layer can be film-formed on the first electrode made of the silicon semiconductor material by a thermal oxidation method. The film f the thermal oxidation method provides favorable close contact of the low-permittivity layer with respect to the first electrode, and foreign matter is less likely to enter an interface between the first electrode and the low-permittivity layer. Therefore, at the interface between the first electrode and the low-permittivity layer, electrical loss can be reduced or prevented. Moreover, since accumulation of foreign matter at the interface between the first electrode and the low-permittivity layer can be reduced or prevented, reliability and a life span of the optical modulator can be improved.

In any one of the optical modulators of the first to fifth configurations, preferably, the first electrode is laminated to the optical waveguide, and the second electrode is laminated to the optical waveguide at the opposite side to the first electrode (sixth configuration). In this case, the optical waveguide exists between the first electrode and the second electrode in a lamination direction of the first electrode, the optical waveguide, and the second electrode. Therefore, an electric field generated by the first electrode and the second electrode can effectively be applied to the optical waveguide.

In the optical modulator of a sixth configuration, the first electrode may include a protrusion portion. The protrusion portion is provided to a surface positioned at the optical waveguide side in the lamination direction of the first electrode, the optical waveguide, and the second electrode, and protrudes toward the optical waveguide (seventh configuration). In this case, an electric field can be concentrated at the optical waveguide by the protrusion portion. Thus, voltage applied between the first electrode and the second electrode can be reduced, and power consumption can be further reduced or prevented.

In the optical modulator of a seventh configuration, when seen in a cross section perpendicular or substantially perpendicular to an extending direction of the optical waveguide, a length of the protrusion portion in a direction perpendicular or substantially perpendicular to the lamination direction may be reduced as approaching the optical waveguide (eighth configuration). For example, in a case in which the protrusion portion has a rectangular or substantially rectangular shape in sectional view, a side surface of the protrusion portion continues at a right angle to the other portion of the surface of the first electrode at the optical waveguide side. On the other hand, as the eighth configuration, in the case in which the length of the protrusion portion in the direction perpendicular or substantially perpendicular to the lamination direction of the electrode and the optical waveguide is reduced as approaching the optical waveguide, the side surface of the protrusion portion can continue comparatively gently to the other portion of the surface of the first electrode at the optical waveguide side. Therefore, electrical loss can be made less likely to occur at the boundary between the protrusion portion and the other portion.

In any one of the optical modulators of the sixth to eighth configurations, preferably, when seen in the cross section perpendicular or substantially perpendicular to the extending direction of the optical waveguide, in the direction perpendicular or substantially perpendicular to the lamination direction of the first electrode, the optical waveguide, and the second electrode, a length of the surface of the first electrode at the optical waveguide side is larger than a length of the optical waveguide (ninth configuration). In this case, the electric field can be applied to the entire or substantially the entire region of the optical waveguide.

In any one of the optical modulators of the first to ninth configurations, for example, preferably, the semiconductor material of the first electrode is a silicon semiconductor material in which silicon is applied with impurity doping (tenth configuration).

In the optical modulator of a tenth configuration, for example, preferably, a concentration of impurities in the first electrode is about 1.0×10¹⁷ cm⁻³ or more and about 1.0×10²² cm⁻³ or less (eleventh configuration). In the first electrode, resistivity decreases and conductivity increases in association with increase in the amount of impurities. When the impurity concentration is about 1.0×10¹⁷ cm⁻³ or more, the first electrode can effectively define and function as an electrode. When the impurity concentration is about 1.0×10²² cm⁻³ or less, precipitation of impurities can be reduced or prevented.

In any one of the optical modulators of the first to eleventh configurations, a refractive index of the first electrode is, for example, less than about 3 (twelfth configuration). In this case, for example, the refractive index of the first electrode becomes less than about 3, corresponding to the concentration (doping amount) of the impurities of the eleventh configuration.

In any one of the optical modulators of the tenth to twelfth configurations, preferably, the first electrode is, for example, a silicon single-crystal substrate (thirteenth configuration).

In any one of the optical modulators of the tenth to twelfth configurations, the first electrode may be an active layer defined by, for example, an SOI substrate (fourteenth configuration).

In any one of the optical modulators of the first to fourteenth configurations, preferably, a main component of the metal material is, for example, a noble metal (fifteenth configuration). In this case, since the metal material which defines the second electrode includes, as the main component, noble metal which is less likely to react chemically, modulation characteristics of the optical modulator are stabilized. Moreover, when the main component of the metal material which defines the second electrode is noble metal, a resistance value of the second electrode can be reduced or prevented and power consumption can be reduced or prevented.

In any one of the optical modulators of the first to fifteenth configurations, preferably, when seen in the cross section perpendicular or substantially perpendicular to the extending direction of the optical waveguide, an area of the first electrode is larger than an area of the second electrode (sixteenth configuration). Since the second electrode is made of the metal material, a resistance value is sufficiently small even when the sectional area is not large. On the other hand, the first electrode is made of the semiconductor material whose conductivity is smaller than that of the metal material, and thus a resistance value can be reduced by making the sectional area of the first electrode larger than that of the second electrode. In this respect, in the sixteenth configuration, since the sectional area of the first electrode is larger than the sectional area of the second electrode, the resistance value of the first electrode is reduced, and thus power consumption can be reduced or prevented.

In any one of the optical modulators of the first to sixteenth configurations, preferably, the second electrode is a signal electrode, and the first electrode is a ground electrode (seventeenth configuration). That is, the second electrode which is the metal electrode is used as the signal electrode, and the first electrode which is the semiconductor electrode is used as the ground electrode. The second electrode is made of the metal material having large conductivity and small attenuation of high-frequency signals. By the second electrode defining and functioning as the signal electrode, drive voltage can be reduced or prevented.

Any one of the optical modulators of the first to seventeenth configurations may further include a metal thin-film with a thickness smaller than the thickness of the first electrode. The metal thin-film is provided to the surface of the first electrode at the optical waveguide side (eighteenth configuration). The metal thin-layer has large conductivity and small attenuation of high-frequency signals. By this metal thin-layer being provided to the surface of the first electrode at the optical waveguide side, drive voltage can be reduced or prevented. Furthermore, in the first electrode, since high-frequency signals propagate more along a surface layer because of a skin effect, conductivity near the surface layer is preferably large. In this respect, by the metal thin-layer being provided to the surface of the first electrode at the optical waveguide side, resistivity can be reduced, and signal attenuation can be reduced or prevented.

In any one of the optical modulators of the first to eighteenth configurations, preferably, a surface layer of the first electrode at the optical waveguide side includes impurity doping at a concentration higher than in another portion of the first electrode (nineteenth configuration). In this case, in the first electrode, a region having high conductivity can be localized near the optical waveguide, and attenuation of high-frequency signals can be reduced or prevented by a skin effect.

The example embodiments of the present invention are described below with reference to the drawings. In the respective drawings, the same or corresponding configurations are given with the same reference characters to omit redundant description.

### First Example Embodiment

### Configuration of Optical Modulator

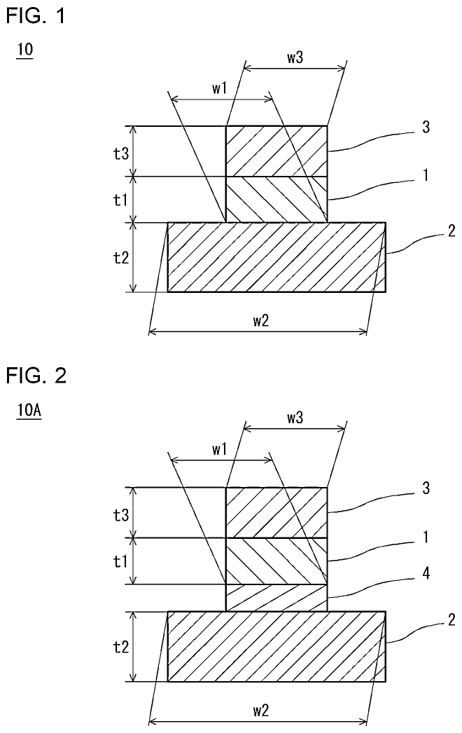

FIG. 1 is a sectional view illustrating a schematic configuration of an optical modulator 10 according to a first example embodiment of the present invention. The optical modulator 10 includes an optical waveguide 1, a first electrode 2, and a second electrode 3. In FIG. 1, a cross section perpendicular or substantially perpendicular to a direction in which the optical waveguide 1 extends is illustrated. Herein, unless otherwise noted, a cross section means a cross section perpendicular or substantially perpendicular to the extending direction of the optical waveguide 1.

As illustrated in FIG. 1, the optical waveguide 1 may have a rectangular or substantially rectangular cross section. The optical waveguide 1 is made of a material having an electro-optic effect. The optical waveguide 1 defines and functions as a light transmission line. As the optical waveguide 1, for example, lithium niobate (LiNbO₃), lithium tantalate (LiTaO₃), lead lanthanum zirconate titanate (PLZT), potassium tantalate niobate (KTN), barium titanate (BaTio₃), or the like may be used. As the optical waveguide 1, for example, electro-optical polymer (EO polymer) may be used.

The first electrode 2 and the second electrode 3 define and function as control electrodes to control light which passes through the optical waveguide 1. Each of the first electrode 2 and the second electrode 3 may have a rectangular or substantially rectangular cross section. The first electrode 2 and the second electrode 3 are disposed to provide a potential difference therebetween to apply an electric field to the optical waveguide 1. The optical waveguide 1 is disposed between the first electrode 2 and the second electrode 3.

In the present example embodiment, the first electrode 2 is laminated to the optical waveguide 1. The second electrode 3 is laminated to the optical waveguide 1 at the opposite side to the first electrode 2. From another perspective, the first electrode 2 and the second electrode 3 are disposed to sandwich the optical waveguide 1 therebetween. In the present example embodiment, the optical waveguide 1 is directly laminated on the first electrode 2, and the first electrode 2 is in contact with the optical waveguide 1. Furthermore, the second electrode 3 is directly laminated on the optical waveguide 1, and the second electrode 3 is in contact with the optical waveguide 1.

The first electrode 2 is made of a semiconductor material. That is, the first electrode 2 is a semiconductor electrode. The semiconductor material used for the first electrode 2 is, for example, typically, a silicon semiconductor material where silicon (Si) is applied with impurity doping. As the semiconductor material, for example, another single-element semiconductor using germanium (Ge) or the like, or a compound semiconductor such as gallium arsenide (GaAs) may be used. Impurities may be either p-type impurities or n-type impurities. For example, in the case in which the semiconductor material is the silicon semiconductor material, a group 3 element, such as boron, is used as the p-type impurities, and a group 5 element, such as phosphorus, arsenic, or antimony, is used as the n-type impurities.

In the case in which the semiconductor material used for the first electrode 2 is the silicon semiconductor material, a concentration of impurities (doping amount) in the first electrode 2 is, for example, preferably, about 1.0×10¹⁷ cm⁻³ or more and about 1.0×10²² cm⁻³ or less. Resistivity of the semiconductor material decreases and conductivity increases in association with increase in the doping amount of impurities. When the doping amount is about 1.0×10¹⁷ cm⁻³ or more, the first electrode 2 can effectively define and function as an electrode. When the doping amount is about 1.0×10²² cm⁻³ or less, precipitation of the impurities can be prevented by a solid solubility limit of impurities in the silicon semiconductor material. A refractive index of the first electrode 2 decreases in association with increase in the doping amount. For example, the refractive index of the first electrode 2 is smaller than about 3.

The range of the doping amount described above is described below in more detail. The reason for the doping amount preferably having the upper limit of about 1.0×10²² cm⁻³ is based on a solid solubility limit of impurities e silicon semiconductor material. In the first electrode 2, when the doping amount exceeds about 1.0×10²² cm⁻³ which is the solid solubility limit, the impurities precipitate and reliability of the first electrode 2 and optical modulator 10 decreases. Meanwhile, the reason for the doping amount preferably having the lower limit of about 1.0×10¹⁷ cm⁻³ is as follows. An index for designing a thickness and width of an electrode includes a skin depth. When the thickness and width of the electrode is smaller than the skin depth, a resistance value rises. Therefore, the thickness and width of the electrode is preferably larger than or equal to the skin depth. When operation in which an optical modulator handles signals at a frequency of 1 GHz or higher is considered and the doping amount is about 1.0×10¹⁷ cm⁻³, for example, conductivity is about 1000 S/m and a skin depth is about 500 μm. For example, considering formation of an electrode from a silicon semiconductor material by microfabrication, the electrode has a thickness of approximately about 500 μm as a limit. Then, from a perspective of securing performance as an electrode, in order to achieve an electrode having conductivity of about 1000 S/m or more, the doping amount may be about 1.0×10¹⁷ cm⁻³ or more.

The first electrode 2 is, for example, a silicon single-crystal substrate. For example, impurity doping is applied in advance to a silicon single-crystal base-material substrate which is a material of the first electrode 2. The base-material substrate is disposed on another substrate and patterning (etching, cutting with a dicing machine, or the like) is applied thereto to form the first electrode 2. The first electrode 2 may be, for example, an active layer of a silicon-on-insulator (SOI) substrate. In this case, the active layer of the SOI substrate is applied with patterning (for example, etching, cutting with a dicing machine, or the like) to form the first electrode 2. Impurities may be further introduced to the first electrode 2 formed in such a manner, by, for example, a thermal diffusion method, ion implantation method, or the like.

The first electrode 2 may be a semiconductor silicon layer formed on a substrate. For example, a silicon layer may be formed on the substrate by sputtering, vapor deposition, CVD, or the like. By introduction of impurities into this silicon layer by, for example, thermal diffusion method, ion implantation method, or the like, the semiconductor silicon layer as the first electrode 2 can be formed.

The second electrode 3 is made of a metal material. That is, the second electrode 3 is a metal electrode. A main component of the metal material used for the second electrode 3 is, for example, a noble metal. The noble metal is, for example, gold (Au). As the noble metal, for example, silver (Ag), platinum (Pt), or the like may be used. The metal material may include a small amount of another metal element, such as Cr or Ti, for example. As the metal material, for example, copper, aluminum, or alloy thereof, or the like may be used.

The second electrode 3 can be laminated with respect to the optical waveguide 1 and the first electrode 2, for example, in the following manner. First, a material substrate having an electro-optic effect is disposed on the first electrode 2, and the material substrate is adhered to the first electrode 2. Then, lithography and etching are applied to the material substrate to form the optical waveguide 1. Next, a metal layer is film-formed on the optical waveguide 1 by sputtering, vapor deposition, or the like. The formed metal film is applied with patterning by lithography and etched to form the second electrode 3.

The second electrode 3 is used as a signal electrode, and the first electrode 2 is used as a ground electrode. Conversely, the first electrode 2 may be used as a signal electrode, and the second electrode 3 may be used as a ground electrode.

In the example illustrated in FIG. 1, the optical waveguide 1 has a thickness t1, which corresponds to a length in a lamination direction of the optical waveguide 1 and the electrodes 2 and 3, and a width w1, which corresponds to a length in a direction perpendicular or substantially perpendicular to the lamination direction. The first electrode 2 has a thickness t2, which corresponds to a length in the lamination direction, and a width w2, which corresponds to a length in the direction perpendicular to the lamination direction. The second electrode 3 has a thickness t3, which corresponds to a length in the lamination direction, and a width w3, which corresponds to a length in the direction perpendicular to the lamination direction.

When in a seen cross section perpendicular or substantially perpendicular to an extending direction of the optical waveguide 1, an area of the first electrode 2 is larger than an area of the second electrode 3. Specifically, a cross-sectional area of the first electrode 2 which is the semiconductor electrode is larger than a cross-sectional area of the second electrode 3 which is the metal electrode. The cross-sectional area of the first electrode 2 and the cross-sectional area of the second electrode 3 are preferably set such that a resistance value of the first electrode 2 substantially matches a resistance value of the second electrode 3. That is, performance of the first electrode 2 as an electrode is preferably equivalent to the second electrode 3. For example, the cross-sectional area of the first electrode 2 may be “(second electrode 3 conductivity/first electrode 2 conductivity)×second electrode 3 cross-sectional area”.

Under a condition where the width w2 of the first electrode 2 is the same or substantially the same as the width w3 of the second electrode 3, in order to match the resistance value of the first electrode 2 with the resistance value of the second electrode 3, a product of the conductivity and the thickness t2 of the first electrode 2 may match a product of the conductivity and the thickness t3 of the second electrode 3. For example, in a case in which the metal material of the second electrode 3 is Au, generally, the thickness t3 of the second electrode 3 is about 0.1 μm or more and about 2.0 μm or less, and the conductivity thereof is about 4.3×10⁷ S/m. On the other hand, since the conductivity of the first electrode 2 is smaller than the conductivity of the second electrode 3, the thickness t2 of the first electrode 2 is larger than the thickness t3 of the second electrode 3. The conductivity of the first electrode 2 varies depending on the doping amount of impurities.

For example, in the case in which the first electrode 2 is made of the silicon semiconductor material and when the impurity doping amount is at the upper limit of about 1.0×10²² cm⁻³, the conductivity of the first electrode 2 is about 1×10⁷ S/m. Here, for example, a value obtained by dividing the conductivity of the second electrode 3 by the conductivity of the first electrode 2 is about 4.3, and the thickness t2 of the first electrode 2 can be about 4.3 times the thickness t3 of the second electrode 3. On the other hand, when the impurity doping amount is at the lower limit of about 1.0×10¹⁷ cm⁻³, the conductivity of the first electrode 2 is about 1000 S/m. Here, a value obtained by dividing the conductivity of the second electrode 3 by the conductivity of the first electrode 2 is about 4.3×10³, and the thickness t2 of the first electrode 2 can be about 4.3×10³ times the thickness t3 of the second electrode 3.

Therefore, for example, a lower limit of the thickness t2 of the first electrode 2 can be about 4.3 times 0.1 μm which is the lower limit of the thickness t3 of the second electrode 3. That is, the thickness t2 of the first electrode 2 can be about 0.43 μm or more. Meanwhile, an upper limit of the thickness t2 of the first electrode 2 can be about 4.3×10³ times about 2.0 μm which is the upper limit of the thickness t3 of the second electrode 3. That is, the thickness t2 of the first electrode 2 can be about 8600 μm (8.6 mm) or less.

However, the thickness t2 of the first electrode 2 is determined also considering, for example, processability in addition to the conductivity of the electrodes 2 and 3 and the thickness t3 of the second electrode 3. For example, in the case in which the first electrode 2 is formed by using the silicon semiconductor material, the thickness t2 of the first electrode 2 is preferably about 500 μm or less from the perspective of processability.

From another perspective, in a case in which high-frequency current is flowed in the first electrode 2, the thickness t2 required for the first electrode 2 can be estimated based on a skin effect. The following formula (1) is a formula for calculation of a skin depth of a conductor.

$$d = \sqrt{\frac{2 ρ}{ω μ}} = \sqrt{\frac{2}{ω μ σ}} = \sqrt{\frac{1}{π f μ σ}} \qquad ( 1 )$$

d: skin depth [m]
p: conductor electrical resistivity [Ω·m]=1/O
ω: alternating current angular frequency [rad/s]=2nf
μ: conductor magnetic permeability [H/m]
o: conductor conductivity [S/m]
f: alternating current frequency [Hz]

Based on the formula (1), the thickness t2 required for the first electrode 2 can be determined. More specifically, the thickness t2 of the first electrode 2 larger than the skin depth calculated by using the formula (1) can reduce electrical resistance of the first electrode 2, which can reduce or prevent unnecessary electrical loss. The first electrode 2 preferably has higher conductivity. However, the conductivity of the first electrode 2 saturates when the doping amount exceeds a certain amount since the impurity doping amount has a solid solubility limit and a state in which the impurities are clustered and inert as a carrier is caused when the doping amount approaches the solid solubility limit. Assuming that the solid solubility limit of the doping amount is about 1.0×10²² cm⁻³, the conductivity of the first electrode 2 is about 1×10⁷ S/m, and the skin depth of the electrical signal at 1 GHz is about 5 μm. However, an actual conductivity is estimated to be about 1×10⁶ S/m, which is one order of magnitude smaller. Therefore, for operation in which signals at about 0.5 GHz or more are handled while providing a band width to the electrical signal, the thickness t2 of the first electrode 2 is preferably about 25 μm or more, for example.

The thickness t2 of the first electrode 2 which is the semiconductor electrode can be measured by, for example, the following method. A first method is a measurement method by SEM observation. In this method, the optical modulator 10 is cut by focused ion beam (FIB) to collect a sample. A cross section of the collected sample is imaged by an SEM, and the thickness t2 of the first electrode 2 can be measured based on the obtained image. A second method is an optical measurement method. In this method, the thickness t2 of the first electrode 2 can directly be measured by interference spectroscopy. The measurement result is the same or substantially the same in either method.

The thickness t3 of the second electrode 3 which is the metal electrode can be measured by, for example, the following method. A first method is the measurement method by the SEM observation described above. A second method is a measurement method using X-rays. In this method, the second electrode 3 is irradiated with X-rays, and an amount of X-ray transmission is measured to obtain attenuation at the second electrode 3. By applying back calculation to the obtained attenuation, the thickness t3 of the second electrode 3 can be measured. The measurement result is substantially the same in either method.

The doping amount in the first electrode 2 can be measured by, for example, epi resistivity measurement, air gap CV measurement, mercury CV measurement, surface charge profiling, secondary ion mass spectrometry, spread resistance measurement, or the like. The measurement result is substantially the same in any of the methods.

When seen in the cross section perpendicular or substantially perpendicular to the extending direction of the optical waveguide 1, the width w2 of the first electrode 2 at the optical waveguide 1 side is larger than the width w1 of the optical waveguide 1. The width w2 of the first electrode 2 at the optical waveguide 1 side means a width of a surface of the first electrode 2, the surface being the closest to the optical waveguide 1. In the present example embodiment, a length of the surface of the first electrode 2, the surface being in contact with the optical waveguide 1, in the direction perpendicular to the lamination direction is the width w2.

### Advantageous Effects

In the optical modulator 10 according to the present example embodiment, the first electrode 2 is made of the semiconductor material, and the second electrode 3 is made of the metal material. That is, among the first electrode 2 and the second electrode 3 which apply an electric field to the optical waveguide 1, the first electrode 2 is the semiconductor electrode. The semiconductor electrode can be configured with a larger thickness while reducing or preventing internal stress when compared to a metal electrode. By the semiconductor electrode being configured to be thick, broadband and high-frequency signals can be applied to the semiconductor electrode while reducing or preventing power consumption. Moreover, the semiconductor electrode is formable while reducing or preventing internal stress, and thus the occurrence of cracks attributed to the internal stress can be reduced or prevented.

The semiconductor material used for the first electrode 2 is, for example, a silicon semiconductor material where Si is applied with impurity doping. For example, the first electrode 2 may be a silicon single-crystal substrate, or may be a semiconductor silicon layer film-formed on a substrate. For example, in the case in which the first electrode 2 is the silicon single-crystal substrate, internal stress of the first electrode 2 can be reduced when compared to the case in which the semiconductor silicon layer is formed on the substrate. Therefore, the first electrode 2 is formable with large thickness while further reducing or preventing internal stress of the first electrode 2.

In the optical modulator 10 according to the present example embodiment, among the first electrode 2 and the second electrode 3 which apply an electric field to the optical waveguide 1, the second electrode 3 is the metal electrode. The metal material which configures the second electrode has higher conductivity than a semiconductor material. Therefore, when compared to a case in which both of the first electrode and the second electrode are semiconductor electrodes, electrical loss can be reduced or prevented.

The second electrode 3 which is the metal electrode can be formed on the optical waveguide 1 by, for example, sputtering, vapor deposition, or the like, without an adhesive layer interposed therebetween. Therefore, the occurrence of light absorption by the adhesive layer can be prevented. Moreover, a change in the refractive index of the optical waveguide 1 due to diffusion of the adhesive layer to the optical waveguide 1 can also be prevented.

In the present example embodiment, the first electrode 2 is laminated to the optical waveguide 1, and the second electrode 3 is laminated to the optical waveguide 1 at the opposite side to the first electrode 2. In this case, in the lamination direction, the optical waveguide 1 exists between the first electrode 2 and the second electrode 3. Therefore, an electric field generated by the first electrode 2 and the second electrode 3 can effectively be applied to the optical waveguide 1.

In the present example embodiment, the second electrode 3 is made of the metal material, and the main component of the metal material is, for example, a noble metal. In a case in which the second electrode 3 is exposed to the atmosphere, an impurity from a material in contact with the second electrode 3 or a gas molecule from another material by degassing may be diffused to the second electrode. In the second electrode 3, the occurrence of such diffusion changes impedance to deviate from an originally designed value. Deviation of impedance of the second electrode 3 from the designed value affects modulation characteristics of the optical modulator 10. In the case in which the main component of the metal material of the second electrode 3 is a noble metal which is less likely to react chemically, the modulation characteristics of the optical modulator 10 are stabilized. Moreover, when the main component of the metal material of the second electrode 3 is a noble metal, the resistance value of the second electrode 3 can be reduced or prevented and power consumption can be reduced or prevented.

In the present example embodiment, when seen in the cross section perpendicular or substantially perpendicular to the extending direction of the optical waveguide 1, in the direction perpendicular or substantially perpendicular to the lamination direction, the length (width w2) of the surface of the first electrode 2 at the optical waveguide 1 side is larger than the length (width w1) of the optical waveguide 1. In this case, the electric field can be applied to the entire or substantially the entire region of the optical waveguide 1. Moreover, stress can be reduced when the optical waveguide 1 is formed with respect to the first electrode 2.

In the present example embodiment, when seen in the cross section perpendicular substantially perpendicular to the extending direction of the optical waveguide 1, the area of the first electrode 2 is larger than the area of the second electrode 3. Since the second electrode 3 is made of the metal material, a resistance value is sufficiently small even when the sectional area is not large. On the other hand, the first electrode 2 is made of the semiconductor material whose conductivity is smaller than that of the metal material, and thus a resistance value can be reduced by making the sectional area of the first electrode larger than that of the second electrode 3. In the present example embodiment, since the sectional area of the first electrode 2 is larger than the sectional area of the second electrode 3, the resistance value of the first electrode 2 is reduced, and thus power consumption can be reduced or prevented.

In the present example embodiment, the second electrode 3 which is the metal electrode is used as the signal electrode, and the first electrode 2 which is the semiconductor electrode is used as the ground electrode. The second electrode 3 is made of the metal material having large conductivity and small attenuation of high-frequency signals. Accordingly, with the second electrode 3 defining and functioning as the signal electrode, drive voltage can be reduced or prevented.

### Second Example Embodiment

FIG. 2 is a sectional view illustrating a schematic configuration of an optical modulator 10A according to a second example embodiment of the present invention. The optical modulator 10A is different from the optical modulator 10 according to the first example embodiment in that the optical modulator 10A includes a low-permittivity layer 4.

In the first example embodiment, the first electrode 2 is in contact with the optical waveguide 1. Even in the case in which the first electrode 2 is in contact with the optical waveguide 1, light can be confined in the optical waveguide 1 by, for example, adjustment of the thickness of the optical waveguide 1 when refractive index difference is large between the first electrode 2 and the optical waveguide 1. However, when the impurity doping amount is increased in the first electrode 2, the refractive index of the first electrode 2 decreases, thus approaching the refractive index of the optical waveguide 1. Therefore, light may be leaked from the optical waveguide 1 to the first electrode 2.

In the present example embodiment, the first electrode 2 is disposed while including a gap with respect to the optical waveguide 1. That is, the first electrode 2 is separate from the optical waveguide 1 in the lamination direction. The first electrode 2 is not in contact with the optical waveguide 1. A size of the gap between the first electrode 2 and the optical waveguide 1 is, for example, about 0.750 μm or more and about 1.675 μm or less. Herein, the size of the gap between the first electrode 2 and the optical waveguide 1 means the shortest distance from the first electrode 2 to the optical waveguide 1. In the case of the present example embodiment, the distance from the first electrode 2 to the optical waveguide 1 in the lamination direction is the shortest distance from the first electrode 2 to the optical waveguide 1.

The low-permittivity layer 4 has a refractive index smaller than the refractive index of the optical waveguide 1. The low-permittivity layer 4 is provided at the gap between the first electrode 2 and the optical waveguide 1. In the optical modulator 10A, the low-permittivity layer 4 is laminated on the first electrode 2, and the optical waveguide 1 is laminated on the low-permittivity layer 4. That is, the optical waveguide 1 is indirectly laminated with respect to the first electrode 2 with the low-permittivity layer 4 interposed therebetween, and the first electrode 2 is not in contact with the optical waveguide 1. The low-permittivity layer 4 preferably covers the entire or substantially the entire surface of the optical waveguide 1, the surface being opposed to the low-permittivity layer 4. Meanwhile, similarly to the first example embodiment, the second electrode 3 is directly laminated on the optical waveguide 1 and in contact with the optical waveguide 1.

A main component of the low-permittivity layer 4 is, typically, for example, SiO₂. As the main component of the low-permittivity layer 4, oxide, such as Al₂O₃, LaAlO₃, LaYO₃, Zno, HfO₂, MgO, or Y₂O₃, or polymer, such as benzocyclobutene (BCB) or polyimide (PI), for example, may be used.

The low-permittivity layer 4 is film-formed on the first electrode 2 by, for example, CVD, vapor deposition, sputtering, or the like. Then, a material substrate having an electro-optic effect is disposed on the low-permittivity layer 4, and the material substrate and the low-permittivity layer 4 can be adhered to one another. Thereafter, as described in the first example embodiment, the optical waveguide 1 and the second electrode 3 may be formed on the low-permittivity layer 4.

In the present example embodiment, the first electrode 2 is not in contact with the optical waveguide 1. Furthermore, the low-permittivity layer 4 with the refractive index smaller than that of the optical waveguide 1 is provided at the gap between the first electrode 2 and the optical waveguide 1. Therefore, when compared to the case in which the first electrode 2 is in contact with the optical waveguide 1, light which passes through the optical waveguide 1 is less likely to leak with respect to the first electrode 2, and less likely to be absorbed by the first electrode 2. Thus, light loss can be reduced or prevented.

For example, when the semiconductor material used for the first electrode 2 is the silicon semiconductor material, the low-permittivity layer 4 made of SiO₂ can be film-formed on the first electrode 2 made of the silicon semiconductor material, by a thermal oxidation method. In this case, close contact of the low-permittivity layer 4 with respect to the first electrode 2 is favorable, and foreign matter is less likely to enter an interface between the first electrode 2 and the low-permittivity layer 4. Therefore, at the interface between the first electrode 2 and the low-permittivity layer 4, electrical loss can be reduced or prevented. Moreover, reliability and a life span of the optical modulator 10A can be improved. This is because the optical modulator 10A may be damaged when foreign matter is accumulated at the interface between the first electrode 2 and the low-permittivity layer 4 and an electric field is concentrated at the accumulated foreign matter.

A seepage depth of evanescent light in the low-permittivity layer 4 can be estimated by using, as a guideline, a wavelength of light (carrier wave) which passes through the optical waveguide 1. In a case in which the first electrode 2 is placed at a distance of the wavelength or more of the carrier wave from the optical waveguide 1, the evanescent light can be prevented from contacting the first electrode 2. Therefore, the size of the gap between the optical waveguide 1 and the first electrode 2, that is, the thickness of the low-permittivity layer 4 (length in the lamination direction) is preferably at or more than the wavelength of the light which passes through the optical waveguide 1.

For example, as the present example embodiment, when the size of the gap between the first electrode 2 and the optical waveguide 1 is about 0.750 μm or more, the thickness of the low-permittivity layer 4 becomes larger than the seepage depth of the evanescent light, and the light which passes through the optical waveguide 1 is less likely to leak to the first electrode 2. As described above, the size of the gap between the first electrode 2 and the optical waveguide 1 may be, for example, about 1.675 μm or less. When the size of the gap between the first electrode 2 and the optical waveguide 1 is about 1.675 μm or less, the intensity of an electric field with respect to the optical waveguide 1 can be ensured without making voltage applied between the first electrode 2 and the second electrode 3 large.

### Third Example Embodiment

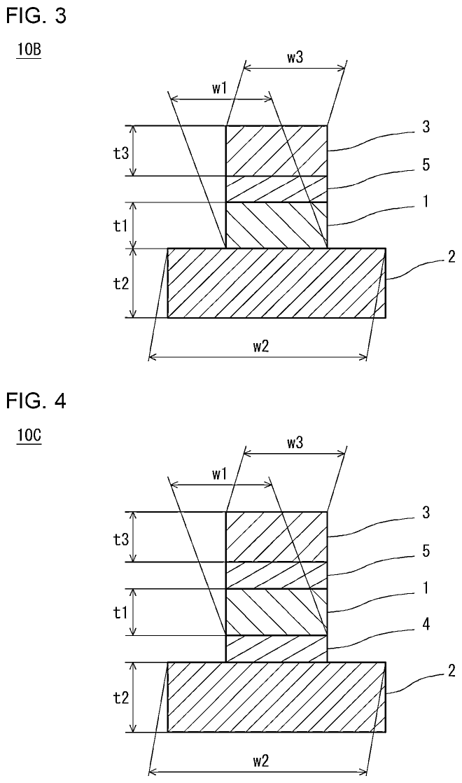

FIG. 3 is a sectional view illustrating a schematic configuration of an optical modulator 10B according to a third example embodiment of the present invention. The optical modulator 10B is different from the optical modulator 10 according to the first example embodiment in that the optical modulator 10B includes a low-permittivity layer 5.

In the present example embodiment, the second electrode 3 is disposed while including a gap with respect to the optical waveguide 1. That is, the second electrode 3 is separate from the optical waveguide 1 in the lamination direction. The second electrode 3 is not in contact with the optical waveguide 1. A size of the gap between the second electrode 3 and the optical waveguide 1 is, for example, about 0.750 μm or more and about 1.675 μm or less. Herein, the size of the gap between the second electrode 3 and the optical waveguide 1 means the shortest distance from the second electrode 3 to the optical waveguide 1. In the case of the present example embodiment, the distance from the second electrode 3 to the optical waveguide 1 in the lamination direction is the shortest distance from the second electrode 3 to the optical waveguide 1.

The low-permittivity layer 5 has a refractive index smaller than the refractive index of the optical waveguide 1. The low-permittivity layer 5 is provided at the gap between the second electrode 3 and the optical waveguide 1. In the optical modulator 10B, the low-permittivity layer 5 is laminated on the optical waveguide 1, and the second electrode 3 is laminated on the low-permittivity layer 5. That is, the optical waveguide 1 is indirectly laminated with respect to the second electrode 3 with the low-permittivity layer 5 interposed therebetween, and the second electrode 3 is not in contact with the optical waveguide 1. The low-permittivity layer 5 preferably covers the entire or substantially the entire surface of the optical waveguide 1, the surface being opposed to the low-permittivity layer 5. Meanwhile, similarly to the first example embodiment, the first electrode 2 is directly laminated on the optical waveguide 1 and in contact with the optical waveguide 1.

Examples of a main component of the low-permittivity layer 5 are similar to those regarding the low-permittivity layer 4 in the second example embodiment. The main component of the low-permittivity layer 5 may be the same as or different from the main component of the low-permittivity layer 4.

The low-permittivity layer 5 is film-formed on the optical waveguide 1 by, for example, CVD, vapor deposition, sputtering, or the like. As described in the first example embodiment, the optical waveguide 1 may be formed on the first electrode 2 before the film formation of the low-permittivity layer 5. Then, a metal layer is film-formed on the low-permittivity layer 5 by, for example, sputtering, vapor deposition, or the like, and as described in the first example embodiment, the second electrode 3 may be formed with respect to the formed metal film.

In the present example embodiment, the second electrode 3 is not in contact with the optical waveguide 1. Furthermore, the low-permittivity layer 5 with the refractive index smaller than that of the optical waveguide 1 is provided at the gap between the second electrode 3 and the optical waveguide 1. Therefore, when compared to the case in which the second electrode 3 is in contact with the optical waveguide 1, light which passes through the optical waveguide 1 is less likely to leak with respect to the second electrode 3, and less likely to be absorbed by the second electrode 3. Thus, light loss can be reduced or prevented.

In the present example embodiment, a size of the gap between the second electrode 3 and the optical waveguide 1 is, for example, about 0.750 μm or more and about 1.675 μm or less. Therefore, similarly to the second example embodiment, the intensity of an electric field with respect to the optical waveguide 1 can be ensured while reducing or preventing light loss.

### Fourth Example Embodiment

FIG. 4 is a sectional view illustrating a schematic configuration of an optical modulator 10C according to a fourth example embodiment of the present invention. The optical modulator 10C is different from the optical modulator 10 according to the first example embodiment in that the optical modulator 10C includes the low-permittivity layer 4 and the low-permittivity layer 5. From another perspective, the optical modulator 10C is a combination of the configuration of the second example embodiment and the configuration of the third example embodiment.

In the present example embodiment, both of the first electrode 2 and the second electrode 3 are disposed while including a gap with respect to the optical waveguide 1. Moreover, the low-permittivity layers 4 and 5 having a refractive index smaller than the refractive index of the optical waveguide 1 are provided at the gap between the first electrode 2 and the optical waveguide 1 and the gap between the second electrode 3 and the optical waveguide 1, respectively. Therefore, light which passes through the optical waveguide 1 becomes less likely to leak to each of the first electrode 2 and the second electrode 3. Thus, in the optical modulator 10C, light loss can be further reduced or prevented comparing to the optical modulators 10A and 10B.

### Fifth Example Embodiment

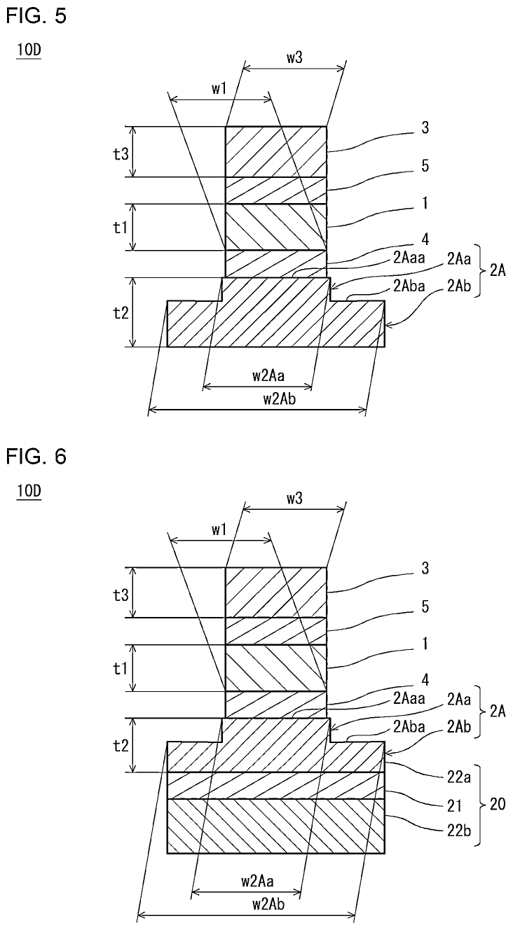

FIG. 5 is a sectional view illustrating a schematic configuration of an optical modulator 10D according to a fifth example embodiment of the present invention. The optical modulator 10D is different form the optical modulator 10C according to the fourth example embodiment, with respect to a configuration of a first electrode 2A.

With reference to FIG. 5, the first electrode 2A includes a protrusion portion 2Aa. In the first electrode 2A, the protrusion portion 2Aa is provided to a surface positioned at the optical waveguide 1 side in the lamination direction, and protrudes toward the optical waveguide 1. In the example of the present example embodiment, the first electrode 2A includes the protrusion portion 2Aa and a base portion 2Ab. The base portion 2Ab is positioned at the opposite side to the optical waveguide 1 in the lamination direction. The protrusion portion 2Aa protrudes from a surface 2Aba of the base portion 2Ab toward the optical waveguide 1. Each of the protrusion portion 2Aa and the base portion 2Ab may have a rectangular or substantially rectangular cross section. In the optical modulator 10D, the low-permittivity layer 4 is laminated on the protrusion portion 2Aa of the first electrode 2A, and the protrusion portion 2Aa is in contact with the low-permittivity layer 4.

When seen in the cross section perpendicular or substantially perpendicular to the extending direction of the optical waveguide 1, a width w2Ab of the base portion 2Ab is larger than a width w2Aa of the protrusion portion 2Aa. The width w2Aa means a width of the surface 2Aaa of the protrusion portion 2Aa, the surface 2Aaa being the closest to the optical waveguide 1. In the present example embodiment, a length of the surface 2Aaa of the protrusion portion 2Aa, the surface 2Aaa being in contact with the low-permittivity layer 4, in the direction perpendicular or substantially perpendicular to the lamination direction is the width w2Aa. The width w2Aa of the protrusion portion 2Aa is larger than the width w1 of the optical waveguide 1.

In the optical modulator 10D of the present example embodiment, an electric field can be concentrated at the optical waveguide 1 by the protrusion portion 2Aa. Thus, voltage applied between the first electrode 2A and the second electrode 3 can be reduced, and power consumption can be reduced or prevented.

In the example in FIG. 5, the first electrode 2A including the protrusion portion 2Aa and the base portion 2Ab is, for example, a silicon single-crystal substrate. By application of lithography and etching to a base-material substrate made of a silicon single-crystal, the protrusion portion 2Aa and the base portion 2Ab can be formed.

FIG. 6 illustrates a modification of the optical modulator 10D according to the fifth example embodiment. In FIG. 6, an SOI substrate 20 is used as a substrate provided with the first electrode 2A. The SOI substrate 20 includes an oxide film 21, and active layers 22a and 22b disposed to sandwich the oxide film 21 therebetween. In the SOI substrate 20, one active layer 22a defines and functions as the first electrode 2A. Utilization of the active layer 22a of the SOI substrate 20 makes patterning for formation of the first electrode 2A easier.

The first electrode 2A may be applied to the optical modulator 10 according to the first example embodiment. In this case, the protrusion portion 2Aa is in contact with the optical waveguide 1. The first electrode 2A may be applied to the optical modulator 10A according to the second example embodiment. In this case, the protrusion portion 2Aa is in contact with the low-permittivity layer 4, and not in contact with the optical waveguide 1. The first electrode 2A may be applied to the optical modulator 10B according to the third example embodiment. In this case, the protrusion portion 2Aa is in contact with the optical waveguide 1.

### Sixth Example Embodiment

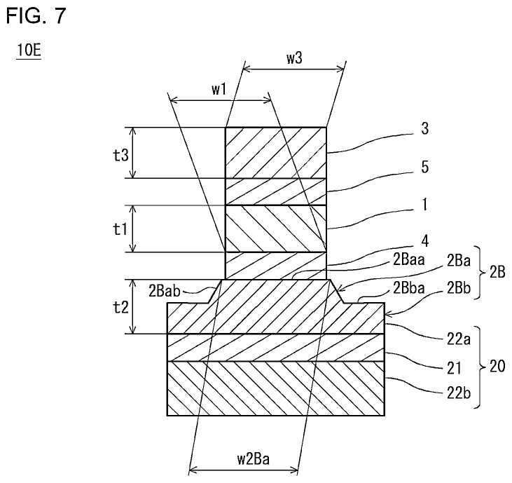

FIG. 7 is a sectional view illustrating a schematic configuration of an optical modulator 10E according to a sixth example embodiment of the present invention. The optical modulator 10E is different form the optical modulator 10D according to the fifth example embodiment, with respect to a configuration of a first electrode 2B.

With reference to FIG. 7, the first electrode 2B includes a protrusion portion 2Ba and a base portion 2Bb. The protrusion portion 2Ba protrudes from a surface 2Bba of the base portion 2Bb toward the optical waveguide 1. When seen in the cross section perpendicular or substantially perpendicular to the extending direction of the optical waveguide 1, a length (width) of the protrusion portion 2Ba in the direction perpendicular or substantially perpendicular to the lamination direction is reduced as approaching the optical waveguide 1. The protrusion portion 2Ba can have the smallest width w2Ba at a surface 2Baa at the optical waveguide 1 side. In the present example embodiment, the surface 2Baa of the protrusion portion 2Ba is in contact with the low-permittivity layer 4. The protrusion portion 2Ba may have a trapezoidal or substantially trapezoidal cross section. In this case, the surface 2Baa of the protrusion portion 2Ba corresponds to a top side of the trapezoid.

In the optical modulator 10E of the present example embodiment, the width of the protrusion portion 2Ba is reduced as approaching the optical waveguide 1 in the cross section of the protrusion portion 2Ba. In this case, a side surface 2Bab of the protrusion portion 2Ba can continue comparatively gently to the surface 2Bba of the base portion 2Bb. More specifically, the side surface 2Bab of the protrusion portion 2Ba can be smoothly connected to the surface 2Bba of the base portion 2Bb while forming an obtuse angle, that is a shape close to a curve. Therefore, when compared to a case in which the side surface 2Bab of the protrusion portion 2Ba is connected to the surface 2Bba of the base portion 2Bb at a right angle, electrical loss can be made less likely to occur at the boundary between the protrusion portion 2Ba and the base portion 2Bb.

In the present example embodiment, the side surface 2Bab of the protrusion portion 2Ba inclines with respect to the surface 2Baa at a constant gradient. However, the gradient of the side surface 2Bab with respect to the surface 2Baa may change.

The first electrode 2B may be applied to each of the optical modulators 10, 10A, and 10B according to the first to third example embodiments.

### Seventh Example Embodiment

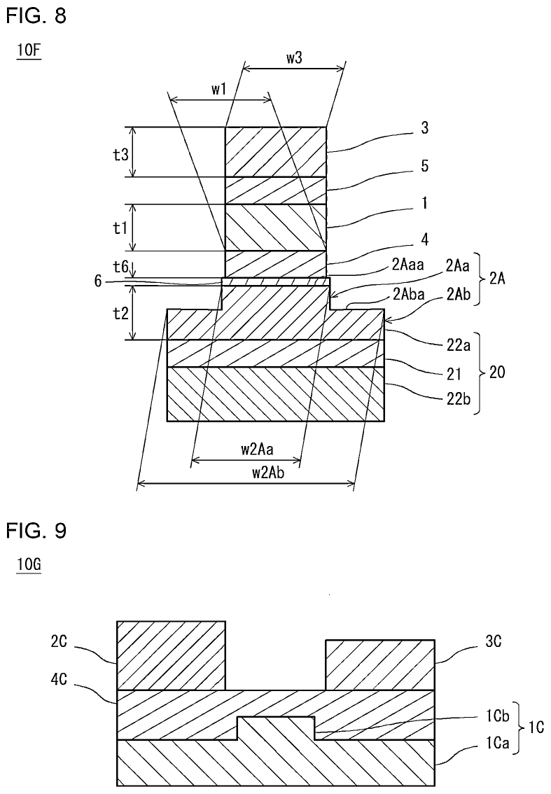

FIG. 8 is a sectional view illustrating a schematic configuration of an optical modulator 10F according to a seventh example embodiment of the present invention. The optical modulator 10F is different from the optical modulator 10D according to the fifth example embodiment in that the optical modulator 10F includes a metal thin-layer 6.

With reference to FIG. 8, the metal thin-layer 6 is provided to the surface of the first electrode 2A at the optical waveguide 1 side. Specifically, the metal thin-layer 6 is provided to the surface 2Aaa of the protrusion portion 2Aa at the optical waveguide 1 side. A thickness t6 of the metal thin-layer 6 is smaller than the thickness t2 of the first electrode 2A. A cross-sectional area of the metal thin-layer 6 is smaller than the cross-sectional area of the first electrode 2A. Moreover, the thickness t6 of the metal thin-layer 6 is smaller than the thickness t3 of the second electrode 3.

The metal thin-layer 6 has large conductivity and small attenuation of high-frequency signals. By this metal thin-layer 6 being provided to the surface 2Aaa of the protrusion portion 2Aa at the optical waveguide 1 side, drive voltage can be reduced or prevented. Furthermore, in the protrusion portion 2Aa of the first electrode 2A, high-frequency signals propagate more along a surface layer because of a skin effect, and thus conductivity near the surface layer is preferably large. In this respect, by the metal thin-layer 6 being provided to the surface of the first electrode 2A at the optical waveguide 1 side, a resistance value can be reduced, and signal attenuation can be reduced or prevented. In this case, the protrusion portion 2Aa is used with respect to low-frequency signals.

In the case in which the first electrode 2A is made of the silicon semiconductor material, as described above, the thickness t2 of the first electrode 2A is, for example, about 0.43 μm or more and about 500 μm or less. The thickness t6 of the metal thin-layer 6 is, for example, about 10% or more and about 50% or less of the thickness t2 of the first electrode 2A. The cross-sectional area of the metal thin-layer 6 is, for example, about 10% or more and about 50% or less of the cross-sectional area of the first electrode 2A. The cross-sectional area of the metal thin-layer 6 may be, for example, about 0.043 μm² or more and about 2500 μm² or less. The metal thin-layer 6 can be formed, for example, by using a metal material similar to the second electrode 3.

The metal thin-layer 6 may be applied to each of the optical modulators 10, 10A, 10B, and 10C of the first to fourth example embodiments. In this case, the metal thin-layer 6 is provided to the surface of the first electrode 2 without a protrusion portion. The metal thin-layer 6 may be applied to the optical modulator 10E according to the sixth example embodiment. In this case, the metal thin-layer 6 is provided to the surface 2Baa of the protrusion portion 2Ba of the first electrode 2B.

### Eighth Example Embodiment

FIG. 9 is a sectional view illustrating a schematic configuration of an optical modulator 10G according to an eighth example embodiment of the present invention. The optical modulator 10G is different from the optical modulator 10C according to the fourth example embodiment, with respect to a configuration of an optical waveguide 1C and arrangement of a first electrode 2C and a second electrode 3C.

With reference to FIG. 9, the optical modulator 10G includes the optical waveguide 1C, the first electrode 2C, the second electrode 3C, and a low-permittivity layer 4C. The optical waveguide 1C includes a substrate portion 1Ca and a ridge portion 1Cb. The ridge portion 1Cb protrudes from a surface of the substrate portion 1Ca. The ridge portion 1Cb substantially defines and functions as an optical waveguide. The low-permittivity layer 4C is laminated to the optical waveguide 1C. More specifically, the low-permittivity layer 4C is laminated with respect to the substrate portion 1Ca and the ridge portion 1Cb.

The first electrode 2C and the second electrode 3C are laminated on the low-permittivity layer 4C. The first electrode 2C and the second electrode 3C are disposed in parallel or substantially in parallel while having a gap therebetween. Specifically, when seen in sectional view of the optical modulator 10G, the first electrode 2C and the second electrode 3C are arranged side by side in a direction perpendicular or substantially perpendicular to a lamination direction of the optical waveguide 1C and the low-permittivity layer 4. In the direction perpendicular or substantially perpendicular to the lamination direction, the first electrode 2C is disposed on one side of the ridge portion 1Cb, and the second electrode 3C is disposed on the other side of the ridge portion 1Cb. The first electrode 2C and the second electrode 3C can form a potential difference therebetween to apply an electric field to the ridge portion 1Cb of the optical waveguide 1C.

The optical modulator 10G according to the present example embodiment also achieves advantageous effects the same as or similar to the optical modulator 10C according to the fourth example embodiment. The optical modulator 10G according to the present example embodiment may be applied with the metal thin-layer 6 of the seventh example embodiment.

### Ninth Example Embodiment

FIG. 10 is a sectional view illustrating a schematic configuration of an optical modulator 10H according to a ninth example embodiment of the present invention. The optical modulator 10H is different form the optical modulator 10 according to the first example embodiment, with respect to a configuration of a first electrode 2D.

With reference to FIG. 10, the first electrode 2D includes a surface layer 2Da at the optical waveguide 1 side, and a remaining portion 2Db. In the example of the present example embodiment, in the first electrode 2D, the surface layer 2Da is disposed to be adjacent to the optical waveguide 1. For example, the surface layer 2Da is a portion present, from a surface of the first electrode 2D at the optical waveguide 1 side, within a about 10% range of a length (thickness) of the first electrode 2D in a lamination direction of the first electrode 2D with respect to the optical waveguide 1. The remaining portion 2Db means a portion of the first electrode 2D excluding the surface layer 2Da. In the first electrode 2D, a concentration of impurity doping in the semiconductor material is higher in the surface layer 2Da than in the remaining portion 2Db. That is, the first electrode 2D has different impurity concentrations, that is, dopant amounts in the surface layer 2Da and in the remaining portion 2Db. For example, the impurity concentration in the surface layer 2Da is higher than the impurity concentration in the remaining portion 2Db by about 10% or more. Such impurity concentration distribution in the first electrode 2D can be formed by thermal diffusion method, ion implantation method, or the like, for example.

In the first electrode 2D, the impurity concentration may drastically change at the boundary between the surface layer 2Da and the remaining portion 2Db, or may be reduced gradually as separating from the surface layer 2Da in the lamination direction. The impurity concentration in the first electrode 2D can be measured by epi resistivity measurement, air gap CV measurement, mercury CV measurement, surface charge profiling, secondary ion mass spectrometry, spread resistance measurement, or the like. The measurement result is the same or substantially the same in any of the methods. A difference between the impurity concentration of the surface layer 2Da and the impurity concentration of the remaining portion 2Db can be confirmed by any of the measurement methods described above. Specifically, by performing the measurement method described above, an impurity concentration profile of the first electrode 2D in the depth direction from the surface at the optical waveguide 1 side is obtained. Based on the obtained impurity concentration profile, an integral average of an impurity concentration of the surface layer 2Da and an integral average of an impurity concentration of the remaining portion 2Db are calculated as the impurity concentration of the surface layer 2Da and the impurity concentration of the remaining portion 2Db, respectively. That is, an integral average of an impurity concentration in the first electrode 2D within the about 10% range of the depth (thickness) of the first electrode 2D from its surface at the optical waveguide 1 side is assumed as the impurity concentration of the surface layer 2Da. Also, an integral average of an impurity concentration within the remaining range is assumed as the impurity concentration of the remaining portion 2Db. The obtained impurity concentration of the surface layer 2Da is higher than the impurity concentration of the obtained remaining portion 2Db by, for example, about 10% or more.

In the optical modulator 10H according to the present example embodiment, the surface layer 2Da of the first electrode 2D at the optical waveguide 1 side is applied with impurity doping at a concentration higher than in the remaining portion 2Db of the first electrode 2. In this case, in the first electrode 2D, a region having high conductivity can be localized near the optical waveguide 1, and attenuation of high-frequency signals can be reduced or prevented by a skin effect.

The first electrode 2D may be applied to each of the optical modulators 10A, 10B, 10C, 10D, 10E, and 10F according to the second to seventh example embodiments.

### Tenth Example Embodiment

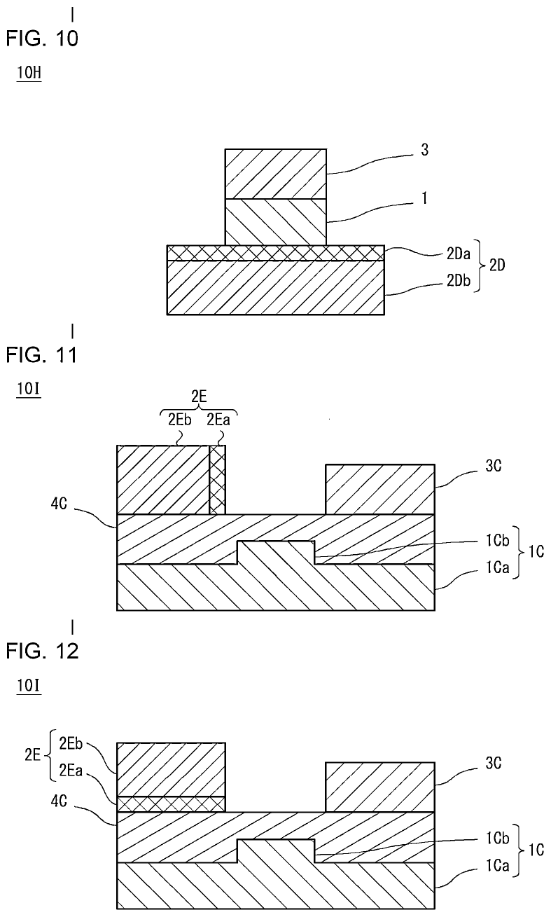

FIG. 11 is a sectional view illustrating a schematic configuration of an optical modulator 10I according to a tenth example embodiment of the present invention. The optical modulator 10I is different form the optical modulator 10G according to the eighth example embodiment, with respect to a configuration of a first electrode 2E.

With reference to FIG. 11, the first electrode 2E includes a surface layer 2Ea at the ridge portion 1Cb side of the optical waveguide 1C, and a remaining portion 2Eb. The surface layer 2Ea at the ridge portion 1Cb side is a surface layer of a portion of the first electrode 2E, the portion being where an electric field applied to the ridge portion 1Cb by the first electrode 2E and the second electrode 3C passes. In the example of the present example embodiment, the surface layer 2Ea is a surface layer of the first electrode 2E, the surface layer being positioned at the ridge portion 1Cb side in the direction (width direction) perpendicular to a lamination direction of the first electrode 2E with respect to the optical waveguide 1C. The ridge portion 1Cb substantially defines and functions as the optical waveguide. For example, the surface layer 2Ea is a portion present within a 10% range of a length of the first electrode 2E in the width direction, from the surface of the first electrode 2E positioned at the ridge portion 1Cb side in the width direction. The remaining portion 2Eb means a portion of the first electrode 2E excluding the surface layer 2Ea. Similarly to the first electrode 2D of the ninth example embodiment described above, in the first electrode 2E, a concentration of impurity doping in the semiconductor material is higher in the surface layer 2Ea than in the remaining portion 2Eb. Therefore, the optical modulator 10I according: example embodiment also achieves advantageous effects the same as or similar to the optical modulator 10H according to the ninth example embodiment.

FIG. 12 illustrates a modification of the optical modulator 10I according to the tenth example embodiment. With reference to FIG. 12, the surface layer 2Ea may be a surface layer of the first electrode 2E, the surface layer being positioned at the optical waveguide 1C side in the lamination direction of the first electrode 2E with respect to the optical waveguide 1. In this case, for example, the surface layer 2Ea is a portion present within a about 10% range of the thickness of the first electrode 2E, from a surface positioned at the optical waveguide 1C side in the lamination direction. This configuration can also achieve advantageous effects the same similar to the optical modulator 10H according to the ninth example embodiment.

Although example embodiments according to the present invention are described above, the present invention is not limited by the example embodiments, and various changes are possible without departing from the scope of the disclosure.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An optical modulator comprising:
an optical waveguide including a material having an electro-optic effect;
a first electrode including a semiconductor material; and
a second electrode including a metal material and positioned to provide a potential difference with respect to the first electrode to apply an electric field to the optical waveguide.

2. The optical modulator according to claim 1, further comprising:
a low-permittivity layer with a refractive index smaller than a refractive index of the optical waveguide; and
a gap between at least the first electrode and the optical waveguide; wherein
the low-permittivity layer is provided at the gap.

3. The optical modulator according to claim 1, further comprising:
a low-permittivity layer with a refractive index smaller than a refractive index of the optical waveguide;
a gap between each of the first electrode and the second electrode and the optical waveguide; wherein
the low-permittivity layer is provided at the gap.

4. The optical modulator according to claim 2, wherein
a size of the gap is about 0.750 μm or more and about 1.675 μm or less.

5. The optical modulator according to claim 2, wherein
the semiconductor material is a silicon semiconductor material in which silicon includes impurity doping; and
a main component of the low-permittivity layer is SiO₂.

6. The optical modulator according to claim 1, wherein
the first electrode is laminated to the optical waveguide; and
the second electrode is laminated to the optical waveguide at an opposite side to the first electrode.

7. The optical modulator according to claim 6, wherein the first electrode includes a protrusion at a surface located at an optical waveguide side in a lamination direction of the first electrode, the optical waveguide, and the second electrode, and protruding toward the optical waveguide.

8. The optical modulator according to claim 7, wherein, when seen in a cross section perpendicular or substantially perpendicular to an extending direction of the optical waveguide, a length of the protrusion portion in a direction perpendicular or substantially perpendicular to the lamination direction is reduced as the protrusion portion approaches the optical waveguide.

9. The optical modulator according to claim 6, wherein, when seen in a cross section perpendicular or substantially perpendicular to an extending direction of the optical waveguide, in a direction perpendicular or substantially perpendicular to a lamination direction of the first electrode, the optical waveguide, and the second electrode, a length of a surface of the first electrode at an optical waveguide side is larger than a length of the optical waveguide.

10. The optical modulator according to claim 1, wherein the semiconductor material is a silicon semiconductor material in which silicon includes impurity doping.

11. The optical modulator according to claim 10, wherein a concentration of impurities in the first electrode is about 1.0×10¹⁷ cm⁻³ or more and about 1.0×10²² cm⁻³ or less.

12. The optical modulator according to claim 1, wherein a refractive index of the first electrode is less than about 3.

13. The optical modulator according to claim 10, wherein the first electrode is a silicon single-crystal substrate.

14. The optical modulator according to claim 10, wherein the first electrode is an active layer of an SOI substrate.

15. The optical modulator according to claim 1, wherein a main component of the metal material is a noble metal.

16. The optical modulator according to claim 1, wherein, when seen in a cross section perpendicular or substantially perpendicular to an extending direction of the optical waveguide, an area of the first electrode is larger than an area of the second electrode.

17. The optical modulator according to claim 1, wherein the second electrode is a signal electrode and the first electrode is a ground electrode.

18. The optical modulator according to claim 1, further comprising a metal thin-layer on a surface of the first electrode at an optical waveguide side and having a thickness smaller than a thickness of the first electrode.

19. The optical modulator according to claim 1, wherein a surface layer of the first electrode at an optical waveguide side includes impurity doping at a concentration higher than in another portion of the first electrode.
